(19) United States
(12) Patent Application Publication
(10) Pub. No.: US 2006/0114756 A1
(43) Pub. Date: Jun. 1, 2006

(54) Light-assisted type magnetic recording head, magnetic recording apparatus and laser-assisted type magnetic recording head manufacturing method

(75) Inventors: Naoto Kojima, Kanagawa (JP); Naoki Ide, Tokyo (JP); Masahiko Kaneko, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/268,086

(22) Filed: Nov. 7, 2005

(30) Foreign Application Priority Data
Nov. 8, 2004 (JP) P2004-324172

(51) Int. Cl. G11B 11/00

(52) U.S. Cl. 369/13.17

(57) ABSTRACT

A laser assisted type magnetic recording head forming a magnetic recording apparatus includes a focusing lens system including an objective lens and a hemispherical or hyper-hemispherical lens and whose effective numerical aperture is greater than 1.0. A recording thin-film magnetic head is built in the inside of the hemispherical or hyper-hemispherical lens. A magnetic recording head and a magnetic recording apparatus are able to record information on a magnetic recording medium while the coercive force of only a predetermined recording portion of the magnetic recording medium can be lowered but a temperature can be prevented from being lowered before magnetic fields are applied.

### CROSS-REFERENCE TO RELATED APPLICATIONS

The present application claims priority from Japanese Patent Application No. JP 2004-324172 filed on Nov. 8, 2004, the disclosure of which is hereby incorporated by reference herein.

### BACKGROUND OF THE INVENTION

The present invention relates to a laser-assisted type magnetic recording head, a magnetic recording apparatus and a laser-assisted type magnetic recording head manufacturing method for use in laser (heat) assisted magnetic recording in which when information is recorded on a magnetic recording medium, a target recording portion is locally heated with irradiation of light, coercive force being locally lowered with this heating to record information on the magnetic recording medium.

A demand of high recording density is increased more and more as a demand of increasing a recording capacity of a recording medium is being increased.

In the magnetic recording, perpendicular magnetization recording can provide high recording density as compared with in-plane recording. In any recording modes, in order to increase recording density and in order to decrease noises, it is necessary to increase coercive force of a recording magnetic layer in a magnetic recording medium.

Information can be magnetically recorded on the magnetic recording medium by forming information pits based on recording magnetic domains of which magnetization directions in specific local areas are changed with application of magnetic fields with different directions to the specific local areas of a ferromagnetic recording magnetic layer of the magnetic recording medium by a magnetic recording head.

A limit of information recording density in the recording system based on the magnetization is determined by boundary fluctuations occurred between recording magnetic domains with different magnetizations, that is, disorder or uncertainty of the boundary surface between the magnetic domains. Also, there is a problem in which fluctuations will appear as jitters of a recording information signal, thereby resulting in an S/N (signal-to-noise ratio) being lowered.

Although the above boundary fluctuations can be suppressed by reducing the size of magnetic particles existing in the magnetic domain, that is, magnetic particles constructing the magnetic layer, if the size of the magnetic particles is reduced as described above, thermal stability is lowered so that the magnetization direction is easily changed with heat. Accordingly, in order to maintain this thermal stability, it becomes necessary to increase coercive force much more.

Accordingly, as mentioned above, in order to decrease the boundary fluctuations of the magnetic domain (pit) which determines the recording density of the magnetic recording medium to further improve stability of information recording and long-term retention of information, it becomes necessary to provide a magnetic recording medium whose coercive force, that is, magnetic anisotropy energy is high.

Concurrently therewith, in the magnetic head on which magnetic recording is effected, it becomes necessary to provide a magnetic head capable of generating strong recording magnetic fields and in which recording magnetic fields can be generated in a very small area in order to increase recording density.

However, there is a limit in obtaining such magnetic head by a smaller structure.

On the other hand, there has been proposed a magnetic recording head capable of effecting a laser-assisted (or heat-assisted) magnetic recording method in which magnetic recording is carried out by temporarily lowering coercive force of a material heated with irradiation of laser light on a predetermined portion of a magnetic recording medium to which magnetic fields should be applied by a magnetic recording head (see The Official Gazette for Japanese Patent No. 2809688, for example).

According to the above-mentioned laser (heat)-assisted recording method based on the illumination of laser light, it is desirable that a quantity of heat capable of sufficiently lowering coercive force of a target magnetic recording portion should be obtained with irradiation of laser light, a diameter of beam spot of laser light should be reduced in order to increase recording density without lowering coercive force at the portions except the target recording portion and that the portion applied with magnetic fields and the spot at which laser light is irradiated should be set to an optimum positional relationship in which they become coincident with each other or close to each other.

As described above, a method using an optical lens is effective for irradiating laser light at a predetermined position with sufficiently high intensity of light.

As described above, when laser-assisted magnetic recording is carried out, it is desirable that laser light should be irradiated on the predetermined portion of the magnetic recording medium by using an optical lens. However, if a lens designed for far-field is used as in the ordinary optical lens system, then the resultant beam spot is larger than the magnetic field area recorded by the magnetic head and hence it is difficult to limitedly record information on a target recording portion by limitedly heating the aforementioned target recording portion without lowering coercive force of other portions.

Further, in this case, since a recording magnetic head is located on the beam spot of laser light, the optical path from the lens to the magnetic recording medium is blocked by this recording magnetic head so that laser light is unable to reach the target position on the magnetic recording medium.

In order to overcome such disadvantages, it is considered to provide an opposing type arrangement in which laser light is introduced into the magnetic recording medium from its back surface. In this case, it is necessary to provide a new control mechanism or control method by which the position of the beam spot formed on the recording film with application of magnetic fields and the focus of the lens can coincide with each other.

Accordingly, it is desirable that the above-mentioned laser-assisted recording should use a near-field type lens.

However, since this near-field type lens is located extremely close to the magnetic recording medium, a problem arises in the arrangement of the recording magnetic head.

### SUMMARY OF THE INVENTION

In view of the aforesaid aspects, the present invention intends to provide a laser-assisted type magnetic recording head having a near-field type arrangement capable of forming sufficiently small beam spot of light on a magnetic recording medium which is to be illuminated with laser light.

The present invention intends to provide a laser-assisted type magnetic recording head in which laser light can be prevented from being blocked by the arrangement of a magnetic head.

The present invention intends to provide a laser-assisted type magnetic recording head of which manufacturing process can be simplified.

Further, the present invention intends to provide a magnetic recording apparatus including this laser-assisted type magnetic recording head.

Furthermore, the present invention intends to provide a method of manufacturing a laser-assisted type magnetic recording head.

According to an aspect of the present invention, there is provided a laser-assisted type magnetic recording head having a focusing lens system including an objective lens and a hemispherical or hyper-hemispherical lens with an effective numerical aperture greater than 1.0 to generate near-field light; and a recording thin-film magnetic head embedded in the hemispherical or hyper-hemispherical lens.

According to the present invention, in the above-mentioned laser-assisted type magnetic recording head, the hemispherical or hyper-hemispherical lens has a bottom surface formed as a planar surface or a surface of a circular cone having a protruding portion at a central portion thereof.

According to the present invention, in the above-mentioned laser-assisted type magnetic recording head, the recording thin-film magnetic head is a perpendicular recording magnetic recording head including a main magnetic pole formed of a thin-film magnetic pole to generate a recording magnetic field, a sub-magnetic pole formed of a thin-film magnetic pole for assisting recording and a magnetic field generating thin-film coil.

According to the present invention, in the above-mentioned laser-assisted type magnetic recording head, the main magnetic pole is located from the protruding portion of the bottom surface to the inside of the hemispherical or hyper-hemispherical lens close to and in parallel to the optical axis of the hemispherical or hyper-hemispherical lens.

According to the present invention, in the above-mentioned laser-assisted type magnetic recording head, the main magnetic pole has a small cross-section at the protruding portion on the bottom surface of the hemispherical or hyper-hemispherical lens.

According to the present invention, in the above-mentioned laser-assisted type magnetic recording head, the main magnetic pole is located close to and in parallel to the optical axis of the focusing lens system, and an aperture structure of near-field light is formed on the optical axis of the focusing lens system.

According to the present invention, in the above-mentioned laser-assisted type magnetic recording head, the recording thin-film magnetic head is a ring-like inductive magnetic head including first and second thin-film magnetic poles having a magnetic gap formed between tip end portions thereof and a magnetic field generating thin-film coil.

According to the present invention, in the above-mentioned laser-assisted type magnetic recording head, the magnetic gap has a center selected at a position close to the optical axis of the focusing lens system, and an aperture structure of near-field light is formed on the optical axis of the focusing lens system.

According to the present invention, in the above-mentioned laser-assisted type magnetic recording head, the recording thin-film magnetic head includes a main magnetic pole including a thin-film magnetic pole to generate recording magnetic fields, a sub-magnetic pole including a recording assisting thin-film magnetic pole and a magnetic field generating thin-film coil, a terminal portion of the coil being extended to an electrode formed on the outer surface of the hemispherical or hyper-hemispherical lens and thereby connected through the electrode to an outside wiring.

Further, according to the present invention, in the above-mentioned laser-assisted type magnetic recording head, the recording thin-film magnetic head includes a magnetic field generating thin-film coil, the coil being formed of a transparent conductive material.

Furthermore, according to the present invention, in the above-mentioned laser-assisted type magnetic recording head, a magnetoresistive effect type thin-film reproducing magnetic head is located in the hemispherical or hyper-hemispherical lens together with the recording thin-film magnetic head.

According to another aspect of the present invention, there is provided a magnetic recording apparatus including a laser light source; a laser-assisted magnetic recording head; and gap adjusting means for controlling a gap between the laser-assisted magnetic recording head and a magnetic recording medium; the laser-assisted magnetic recording head including a recording thin-film magnetic head for generating a magnetic field to the magnetic recording medium and a focusing lens system for focusing laser light from the laser light source on the magnetic recording medium; and the focusing lens system including an objective lens and a hemispherical or hyper-hemispherical lens, an effective numerical aperture thereof being selected to be greater than 0.1, wherein when information is recorded on the magnetic recording medium, information is recorded on the magnetic recording medium based on magnetic fields generated from the thin-film magnetic head by focusing laser light from the laser light source on the magnetic recording medium through the focusing lens system in the state in which the gap of the laser-assisted magnetic recording head relative to the magnetic recording medium is adjusted by the gap adjusting means.

According to the present invention, in the above-mentioned magnetic recording apparatus, the gap adjusting means includes a flying slider having the laser-assisted magnetic head mounted thereon.

According to the present invention, the above-mentioned magnetic recording apparatus further includes detecting means for detecting reflected light of the laser light irradiated on the magnetic recording medium, a gap servo signal of the gap adjusting means being obtained by a detected output from the detecting means.

According to the present invention, in the above-mentioned magnetic recording apparatus, the laser-assisted magnetic recording head is mounted on a biaxial actuator, the biaxial actuator adjusting two axes of the optical axis direction of the laser-assisted magnetic recording head and the direction perpendicular to the optical axis direction of the laser-assisted magnetic recording head.

According to the present invention, in the above-mentioned magnetic recording apparatus, the reflected light detecting means generates from its detected output a focusing servo signal by which the optical system of the laser-assisted magnetic recording head is focus-servo-controlled relative to the magnetic recording medium.

According to the present invention, in the above-mentioned magnetic recording apparatus, the reflected light detecting means generates from its detected output a tracking servo signal by which the recording thin-film magnetic head of the laser-assisted magnetic recording head applies magnetic fields to the magnetic recording medium.

Further, according to the present invention, the above-mentioned magnetic recording apparatus further includes a magnetic recording medium having concavities and convexities formed as lands and grooves with respect to a direction crossing a longitudinal direction of recording tracks; and detecting means for detecting reflected light of the laser light irradiated in the magnetic recording medium, a detected output of the detecting means generating a tracking servo signal by which the recording thin-film magnetic head of the laser-assisted magnetic recording head applies magnetic heads to the magnetic recording medium.

Furthermore, according to the present invention, in the above-mentioned magnetic recording apparatus, the magnetic recording medium includes a soft magnetic layer formed under a recording layer.

According to a further aspect of the present invention, there is provided a laser-assisted type magnetic recording head manufacturing method which includes forming a groove on an end face of a first optical member which passes light of a predetermined wavelength band; forming a recording thin-film magnetic head within the groove; covering the recording thin-film magnetic head with an insulating film including a protecting film; planarizing and polishing the protecting film; forming a joint body by joining a second optical member, which passes light of the same wavelength band as the wavelength band, on the optical member across the recording thin-film magnetic head within the groove; and forming a hemispherical or hyper-hemispherical optical lens having the thin-film magnetic head embedded therein by spherical-polishing the joint body.

Further, according to the present invention, in the above-mentioned laser-assisted type magnetic recording head manufacturing method, the step of forming the recording thin-film magnetic head within the groove includes forming a first thin-film magnetic pole made of a high magnetic permeability material within the groove; forming a magnetic field generating thin-film coil made of a metal conductive thin-film after an insulating film is formed on the first thin-film magnetic pole; forming an insulating film on the magnetic field generating thin-film coil; and forming a second magnetic pole made of a high magnetic permeability material on the insulating layer.

Furthermore, according to the present invention, the laser-assisted type magnetic recording head manufacturing method further includes forming an electrode on the outer surface of the hemispherical or hyper-hemispherical optical lens, wherein a terminal portion of the magnetic field generating thin-film coil within the hemispherical or hyper-hemispherical optical lens is extended to the joint surface of the first optical member relative to the second optical member and thereby connected to the electrode on the outer surface of the hemispherical or hyper-hemispherical optical lens in the step of forming the magnetic field generating thin-film coil.

As described above, in the laser-assisted type magnetic recording head according to the present invention, since the focusing lens system includes the objective lens and the hemispherical or hyper-hemispherical lens with the effective numerical aperture greater than 1.0 to generate near-field light, the diameter of a beam spot on a target magnetic recording medium can be reduced sufficiently. Further, according to the present invention, in the inside of the hemispherical or hyper-hemispherical lens of the focusing lens system, it is possible to effectively avoid light from being shielded by the magnetic heads within the lens.

Specifically, according to the present invention, since the focusing lens system has a numerical aperture greater than 1.0, that is, light is introduced into the focusing lens system with a wide angle, although the magnetic head is located between the lenses, it is possible to decrease the effect in which light is shielded by the magnetic head. Also, since this magnetic head has the arrangement of the thin-film head, this light-shielding effect can be suppressed much more. Accordingly, only a predetermined recording portion of the magnetic recording medium can be sufficiently heated by laser light of a light beam spot with a small diameter and hence coercive force can be lowered locally.

Then, since the recording magnetic head is located within the lens, the lens can be made sufficiently close to the magnetic recording medium.

Further, the position at which recording magnetic fields are applied and the laser-assisted spot can be placed in an ideal positional relationship, that it, both of them can be made substantially coincident or close to each other.

Further, since the magnetic head is located within the lens as described above, the magnetic head can be held mechanically with high stability. Hence, the magnetic head can be made sufficiently thin and small by the thin-film technology and magnetic fields can be applied to very small areas.

Furthermore, since the magnetic recording apparatus according to the present invention uses the above-mentioned laser-assisted type magnetic recording head of the present invention, there can be achieved similar effects. Then, since the magnetic recording apparatus according to the present invention includes the gap adjusting means, the gap of the laser-assisted type magnetic recording head relative to the magnetic recording medium can be set to be a predetermined one and hence the magnetic recording apparatus of the present invention can perform stable recording operations.

Then, since the laser-assisted arrangement uses the laser light, the gap servo signal, the focusing servo signal and the tracking servo signal can be obtained from reflected light (returned light) of light from the magnetic recording medium and the positional relationship between the magnetic head and the magnetic recording medium can fall within a predetermined relationship without providing special means.

Also, according to the manufacturing method of the present invention, since the spherical or hyper-hemispherical lens which houses therein the recording thin-film magnetic head constructing the laser-assisted type magnetic recording head can be manufactured at the same time the lens is formed, the manufacturing process can be simplified and a signal relationship between the lens and the magnetic head can be improved in accuracy.

### BRIEF DESCRIPTION OF THE DRAWINGS

FIG. 1 is a schematic diagram showing an arrangement of a magnetic recording apparatus including a laser-assisted type magnetic recording head according to the present invention;

FIG. 2 is a schematic perspective view showing an arrangement of a focusing lens system constructing a magnetic recording apparatus according to the present invention;

FIGS. 3A and 3B are schematic diagrams showing an example of an arrangement of a hemispherical/hyper-hemispherical lens constructing a laser-assisted type magnetic recording head according to the present invention, respectively;

FIG. 4A is a schematic cross-sectional view showing an arrangement of an example of a hemispherical or hyper-hemispherical lens according to the present invention;

FIG. 4B is a cross-sectional view showing a structure of a main portion of this hemispherical or hyper-hemispherical lens;

FIG. 5A is a schematic cross-sectional view showing an arrangement of other example of a hemispherical or hyper-hemispherical lens according to the present invention;

FIG. 5B is a cross-sectional view showing a structure of a main portion of this hemispherical or hyper-hemispherical lens;

FIG. 6A is a schematic cross-sectional view showing an arrangement of an example in which an aperture forming means is provided on the bottom surface of the hemispherical or hyper-hemispherical lens constructing the laser-assisted type magnetic recording head according to the present invention;

FIG. 6B is a cross-sectional view showing a structure of main portion of the hemispherical or hyper-hemispherical lens;

FIG. 7 is a schematic diagram showing a relationship between the hemispherical or hyper-hemispherical lens and a signal power supply for controlling an electric current of a thin-film magnetic field generating thin-film coil constructing a recording thin-film magnetic head in a magnetic recording apparatus according to the present invention;

FIG. 8 is a schematic cross-sectional view showing an arrangement of an example in which a magnetic reproducing head is formed within the hemispherical or hyper-hemispherical lens of the laser-assisted type magnetic recording head according to the present invention;

FIG. 9A is a schematic perspective view showing an example of an arrangement in which a laser-assisted type magnetic recording head according to the present invention is composed of a biaxial actuator in the state in which the laser-assisted type magnetic recording head is opposed to a magnetic recording medium;

FIG. 9B is a schematic perspective view showing an arrangement of an example of this biaxial actuator;

FIG. 10 is a diagram showing a schematic arrangement of an example of an arrangement in which the laser-assisted type magnetic recording head according to the present invention flies as the opposing magnetic recording medium is moved or rotated;

FIGS. 11A to 11D are process diagrams useful for explaining an example of a laser-assisted type magnetic recording head manufacturing method according to the present invention, respectively;

FIGS. 12A to 12C are process diagrams showing a laser-assisted type magnetic recording head manufacturing method according to the present invention, respectively;

FIGS. 13A to 13D are process diagrams showing a laser-assisted type magnetic recording head manufacturing method according to the present invention, respectively; and

FIGS. 14A to 14C are process diagrams showing a laser-assisted type magnetic recording head manufacturing method according to the present invention, respectively.

### DETAILED DESCRIPTION

Embodiments of the present invention will now be described below with reference to the drawings and it is needless to say that the present invention is not limited to those embodiments.

First, a magnetic recording apparatus according to an embodiment of the present invention will be described together with a magnetic recording head according to an embodiment of the present invention constructing this magnetic recording apparatus.

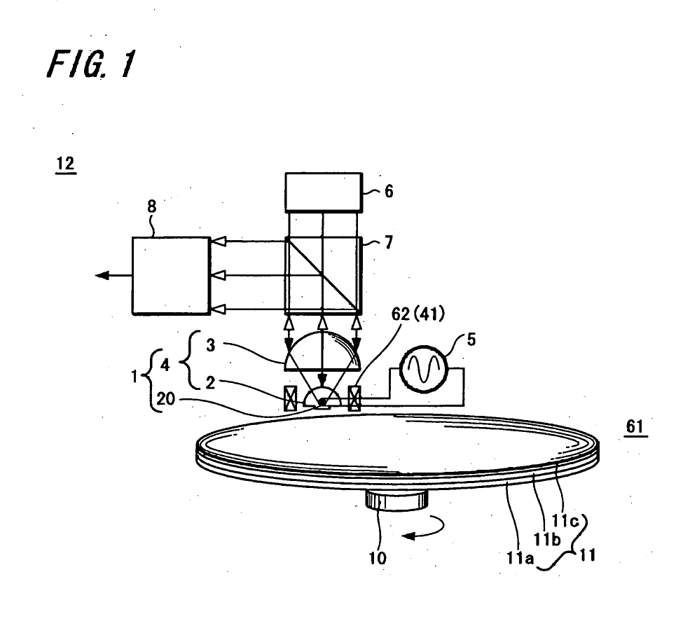

FIG. 1 of the accompanying drawings is a schematic diagram showing an arrangement of a magnetic recording apparatus including a laser-assisted type magnetic recording head according to the present invention.

As shown in FIG. 1, a magnetic recording apparatus 12 includes a laser light source 6, a laser-assisted type magnetic recording head 1, an arrangement portion 61 for a magnetic recording medium 11 and in which the magnetic recording medium 11, for example, a magnetic disc is located and thereby rotated, a beam splitter 7 located between the laser light source 6 and the laser-assisted type magnetic recording head 1 and a reflected light detecting means 8 for detecting reflected light (returned light) of light irradiated on the magnetic recording medium 11 from the laser-assisted type magnetic recording head 1, in which desired servo signals, for example, a focusing servo signal, a tracking servo signal and other suitable servo signals are obtained by calculating detected outputs from the reflected light detecting means 8.

The laser-assisted type magnetic recording head 1 is composed of an objective lens 3 and a hemispherical or hyper-hemispherical lens (hereinafter referred to as a “hemispherical/hyper-hemispherical lens” for simplicity) 2. The laser-assisted type magnetic recording head 1 includes a focusing lens system of which effective numerical aperture is greater than 1.0 and a recording thin-film magnetic head 20 is located within the hemispherical/hyper-hemispherical lens 2.

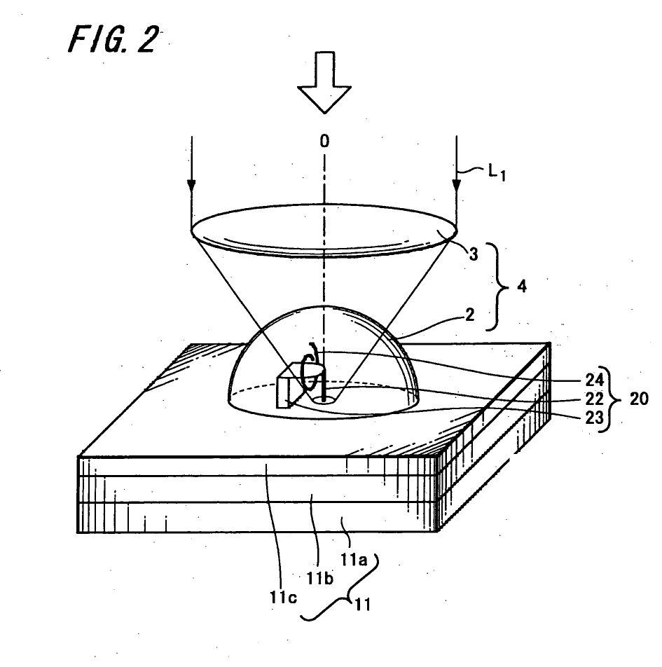

FIG. 2 is a schematic perspective view showing an arrangement of the focusing lens system constructing this magnetic recording apparatus.

The recording thin-film magnetic head 20 may be constructed so as to have a magnetic head arrangement for effecting perpendicular magnetic recording and FIG. 2 shows an example of such a magnetic head arrangement for effecting perpendicular magnetic recording. As shown in FIG. 2, this perpendicular recording type recording head 20 includes a recording magnetic field generating magnetic pole 22 formed of a thin-film magnetic pole, a recording-assistant sub-magnetic pole 23 and a magnetic field generation thin-film coil 24.

A signal power supply 5 is connected to this thin-film coil 24 and thereby a recording signal electric current is introduced into the thin-film coil 24.

An arrangement portion 61 of the magnetic recording medium 11 is rotated by the spindle motor 10 in the state in which a disc-like magnetic recording medium, for example, is held thereon.

The magnetic recording medium 11, for example, hard disk includes a substrate 11a made of glass, for example, a recording layer 11c and a soft magnetic layer 11b having high magnetic permeability formed on the recording layer 11c at its side opposing the substrate 11c in the perpendicular recording, for example.

In the magnetic head having the above arrangement, when a recording signal electric current is applied to the thin-film coil 24, magnetic flux is generate along the central axis of the thin-film coil 24. The thus generated magnetic flux passes the main magnetic pole 22 and magnetization is concentrated at the tip end portion opposing the magnetic recording medium 11. In this case, if the above-mentioned soft magnetic layer 11b exists on the magnetic recording medium 11, then perpendicular magnetic flux is generated on the medium surface due to reflection effect so that perpendicular recording magnetic fields are applied to the recording layer 11c. At the same time, since generated recording magnetic fields are distributed only in substantially the same range as the diameter of the tip end of the main magnetic pole 22 due to the reflection effect if the soft magnetic layer 11b, if the tip end of the main magnetic pole 2 is microminiaturized, then it becomes possible to locally apply recording magnetic fields.

In the above-mentioned arrangement, the lens system 4 consisting of a combination of the objective lens 3 and the hemispherical/hyper-hemispherical lens 2 has a so-called SIL (Solid Immersion Lens) or Super-SIL arrangement for use in near-field optical recording to generate near-field light of which effective numerical aperture exceeds 1.0.

It is customary that a diameter of a spot of light beam focused by an objective lens alone can be reduced to approximately λ/NA_{obj} due to diffraction limit of light where λ represents the wavelength of light and NA_{obj} represents the numerical aperture of the objective lens. However, according to the above-mentioned SIL lens system or Super-SIL lens system, a spot diameter can be reduced and decreased up to 1/n and 1/n² at the focusing screen, that is, the bottom surface of the hemispherical and hyper-hemispherical optical lenses where n represents the refractive index of each optical lens.

Further, if the bottom surface of the optical lens having these arrangements is opposed to the magnetic recording medium and the gap between the optical lens and the magnetic recording medium is selected to be less than λ/10, due to focusing action of near-field light, beam spots with diameters of 1/n and 1/n² can be formed on the magnetic recording medium 11 in the same way as that in the bottom surface of the optical lens 2.

In the above-mentioned arrangement shown in FIG. 1, laser light from the laser light source 6 is passed through the beam splitter 7, introduced into the focusing lens system 4, focused by the objective lens 3 and then introduced into the hemispherical/hyper-hemispherical lens 2. A focused beam spot of this incident light is formed on the bottom surface of the hemispherical/hyper-hemispherical lens 2 and the magnetic recording medium 11 which is closely opposed to this bottom surface. Accordingly, by the magnetic field generating main magnetic pole 22 of the recording thin-film magnetic head 20 located on this bottom surface side, a very small spot of laser light is irradiated on the magnetic recording medium 11 at its target recording portion or at its portion near the target recording portion with application of recording magnetic fields. Accordingly, a temperature in a target perpendicular recording portion is raised by the spot illuminated with laser light and hence coercive force of this perpendicular recording portion can be lowered locally. That is, laser (heat) assist is carried out.

Then, light used in this laser-assist is partly reflected on the surface of the magnetic recording medium 11, introduced through the lens system 4 into the beam splitter 7, whereby the optical path is separated from the incident optical path and light is introduced into the reflected light detecting means 8.

This reflected light detecting means 8 detects far-field components from the reflected light by using a plurality of split photodiodes similarly to a photo-detecting means in an optical pickup for use with an ordinary optical disc, for example. A focusing servo signal, a tracking servo signal and the like are obtained from these outputs by predetermined calculations. Further, in the arrangement according to the present invention, of reflected light from the surface of the magnetic recording medium, a quantity of reflected light of the near-field component is changed in proportion to a gap between the focusing lens system 4 and the magnetic recording medium 11, that is, a gap amount. Accordingly, a gap servo signal can be obtained based on a quantity of reflected light of this near-field component.

Focusing control and tracking control are carried out based on these servo signals and further gap control is carried out by the above-mentioned gap adjusting means 62.

The focusing control, the tracking control and the gap control may be carried out by a biaxial actuator. This biaxial actuator is mounted on the focusing lens system 4 as will be described later on.

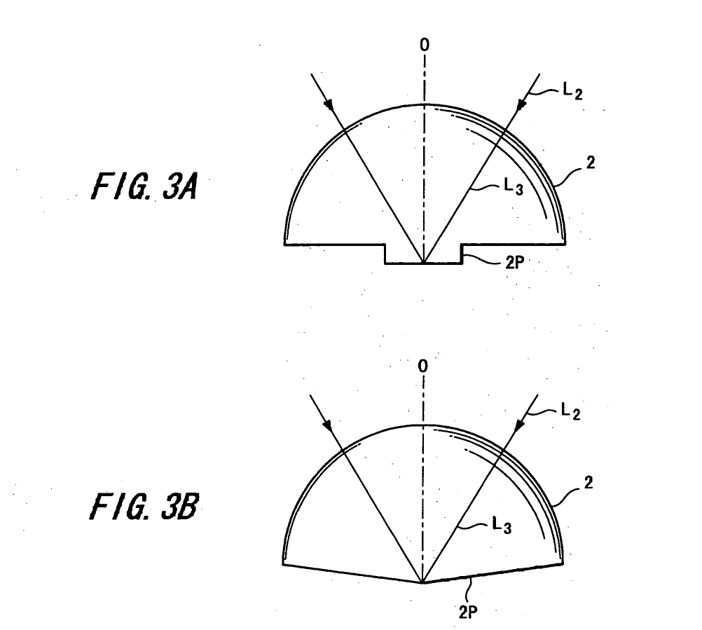

The hemispherical/hyper-hemispherical lens 2 can take various kinds of arrangements. For example, as shown in FIGS. 1 and 3A, a protruded shape portion 2P which protrudes to the outside may be formed on the central portion of the bottom surface and a focusing point may be formed on the protruded shape portion 2P. This protruded portion 2P may be shaped as a cylinder shown in FIGS. 1 and 3A or it may be shaped as a cone shown in FIG. 3B. Alternatively, the protruded portion 2P may be shaped as a truncated cone, a prism or a curve shape of a curved surface. In this manner, it is possible to avoid the bottom surface of the hemispherical or hyper-hemispherical optical lens 2 from being brought in contact with the surface of the magnetic recording medium inadvertently at the peripheral portion of the focusing portion by the inclination of the lens when the gap between the optical lens 2 and the magnetic recording medium 11 is set to be a narrow clearance (gap) to form a beam spot of near-field light by protruding the bottom surface of the focusing portion.

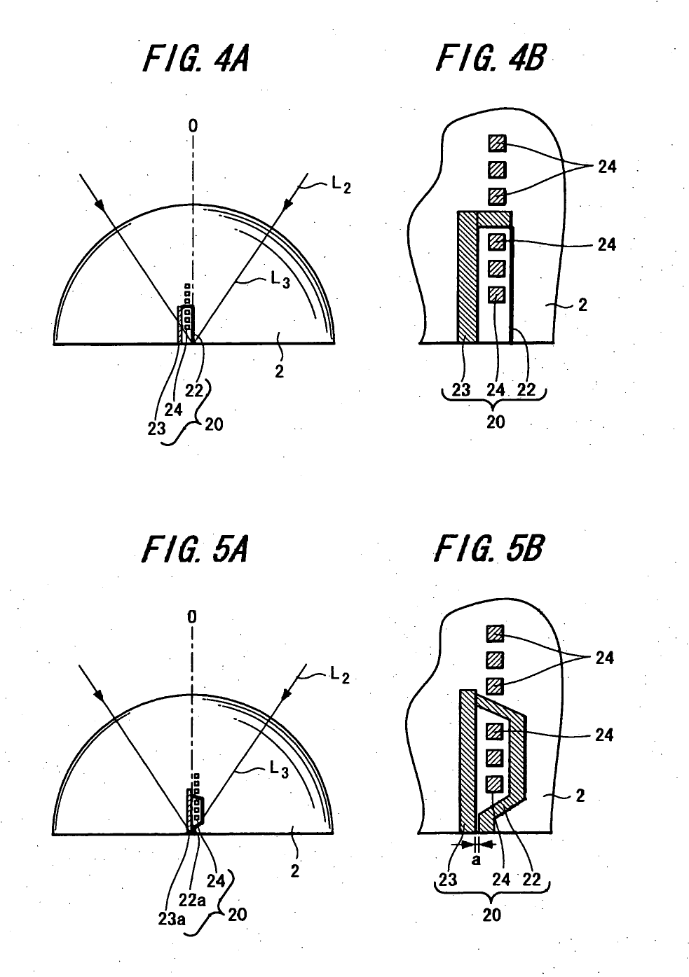

FIGS. 4A and 4B are respectively a schematic cross-sectional view showing an arrangement of an example of the hemispherical/hyper-hemispherical lens 2 constructing the perpendicular recording laser-assisted type magnetic recording head 1 according to the present invention and a cross-sectional view of a main portion of this hemispherical or hyper-hemispherical lens 2.

In this case, a main magnetic pole 22 made of a thin-film coil to generate recording magnetic fields and a sub-magnetic pole 23 for assisting the main magnetic pole 23 are laminated with each other within the hemispherical/hyper-hemispherical lens 2 and the sub-magnetic pole 23 has a thin-film coil 24 wound around its L-like bending portion which is magnetically coupled to the main magnetic pole 22. Then, the main magnetic pole 22 is formed at an optical axis O of incident light L₂ and focused light L₃ of the hemispherical/hyper-hemispherical lens 2 or it is closely formed in parallel to the optical axis O.

In the magnetic recording head for laser-assisted magnetic recording and the magnetic recording apparatus, the position at which beam spot is formed at a target predetermined portion of the magnetic recording medium 11 and the position at which magnetic fields are applied to the target predetermined portion of the magnetic recording medium 11 should be accurately matched with each other. In order to increase recording efficiency, it is desirable that the position at which recording magnetic fields are applied and the center of the beam spot should be made as close as possible because temperature gradient and maximum achievable temperature are lowered as a distance therebetween is increased and recording efficiency is decreased unavoidably. However, if the position at which recording magnetic fields are applied and the center of beam spot are distant from each other, then it becomes easy to locate the magnetic poles so as to avoid light from being shielded. From the results obtained when characteristics in which temperatures are raised on the surface of the magnetic recording medium with illumination of the beam spot of laser light were analyzed, it is to be appreciated that a distance between the center at which recording magnetic fields are applied and the center of the beam spot may be selected to be under several 100s of nanometers. More specifically, it is desirable that a proper distance should fall within a range of from 50 to 100 nm.

According to the arrangement of the magnetic recording head of the present invention, by a magnetic recording head manufacturing method of the present invention which will be described later on, it is possible to accurately select a relative position between the position of magnetic fields applied to the magnetic recording medium 11 by the above-mentioned main magnetic pole 22 and the position of the beam spot formed on the magnetic recording medium 11 by the focused light L₃ based on the laser light L₁.

Also, in this embodiment, although the main magnetic pole 22 is formed within the optical path of the incident laser light L₁ and the focused light L₃, the magnetic pole 22 is formed close to and parallel to the above optical path outside the optical axis. Further, in order to narrow magnetic fields applied to the magnetic recording medium 11, the main magnetic pole 22 is formed with the cross-section smaller than the cross-section of the top side of the hemispherical/hyper-hemispherical lens 2 at the bottom surface of the hemispherical/hyper-hemispherical lens 2, for example, the protruded portion. However, on the top side opposite to the bottom surface, a bundle of light of incident side of the incident light L₂ to the hemispherical/hyper-hemispherical lens 2 of the incident laser light L₁ to the focusing lens system 4, that is, the optical path diameter is large and the cross-sectional shape, for example, the diameter of the main magnetic pole 22 is small and hence it is possible to avoid the optical path of the focused light L₃ from being shielded and obstructed by the main magnetic pole 22.

Also, although the sub-magnetic pole 23 is formed to be large in cross-section, for example, the sub-magnetic pole 23 is formed to be wide and thick as compared with the main magnetic pole 22, since the sub-magnetic pole 23 is distant from the bottom surface of the hemispherical/hyper-hemispherical lens 2 finally formed by the focused light L₃ and the beam spot on the magnetic recording medium 11, a quantity in which the whole of the optical path of the focused light L₃ is shielded by the sub-magnetic pole 23 becomes less than a constant quantity.

Having analyzed by optical simulation the state in which the focused light L₃ is shielded by the sub-magnetic pole 23, although aberration on the bottom surface of the hemispherical/hyper-hemispherical lens 2 is increased and a quantity of light on the beam spot is decreased, it is to be appreciated that the diameter of the beam spot was hardly changed. Then, since the quantity of light on the beam spot can be compensated for by increasing incident power of the incident laser light L₁, it becomes possible to illuminate a predetermined portion of the magnetic recording medium 11 with laser light as it is desired.

FIGS. 5A and 5B are respectively a schematic cross-sectional view showing an arrangement of a hemispherical or hyper-hemispherical lens according to other embodiment of the present invention and a cross-sectional view of a main portion of this hemispherical or hyper-hemispherical lens.

In this embodiment, there is constructed a laser-assisted type magnetic recording head which constructs an inductive type magnetic recording head 20 having a ring type arrangement for carrying out in-plane magnetic recording which is widely used by a magnetic recording head for use with a hard disk.

As shown in FIG. 5B, this ring inductive type recording thin-film magnetic recording head 20 includes a first thin-film magnetic pole 22a, which might be called a “upper magnetic pole”, made of a high magnetic permeability material and a second thin-film magnetic pole 23a, which might be called a “lower magnetic pole”, made of a high magnetic permeability material. These magnetic poles 22a and 23a are opposed to each other across a narrow gap shown by solid arrows a in FIG. 5B, that is, a magnetic gap.

The magnetic gap is selected in such a manner that its center is located at the position close to the optical axis O. Also in the case of this ring inductive type recording thin-film magnetic recording head 20, an aperture structure can be formed on the bottom surface of the hemispherical/hyper-hemispherical lens 2 as will be described later on.

With respect to the magnetic flux generated from the magnetic field generating thin-film coil 24, magnetic fields based on leakage magnetic fields from the magnetic gap within the closed magnetic path formed by the first and second thin-film magnetic poles 22a and 23a are applied to the magnetic recording medium 11 as recording magnetic fields. The magnetic head having the inductive type arrangement is able to perform magnetic recording by using an in-plane component parallel to the medium surface of the magnetic recording medium 11.

However, in some case, the above-mentioned inductive type magnetic head is able to perform perpendicular magnetic recording by using a perpendicular component.

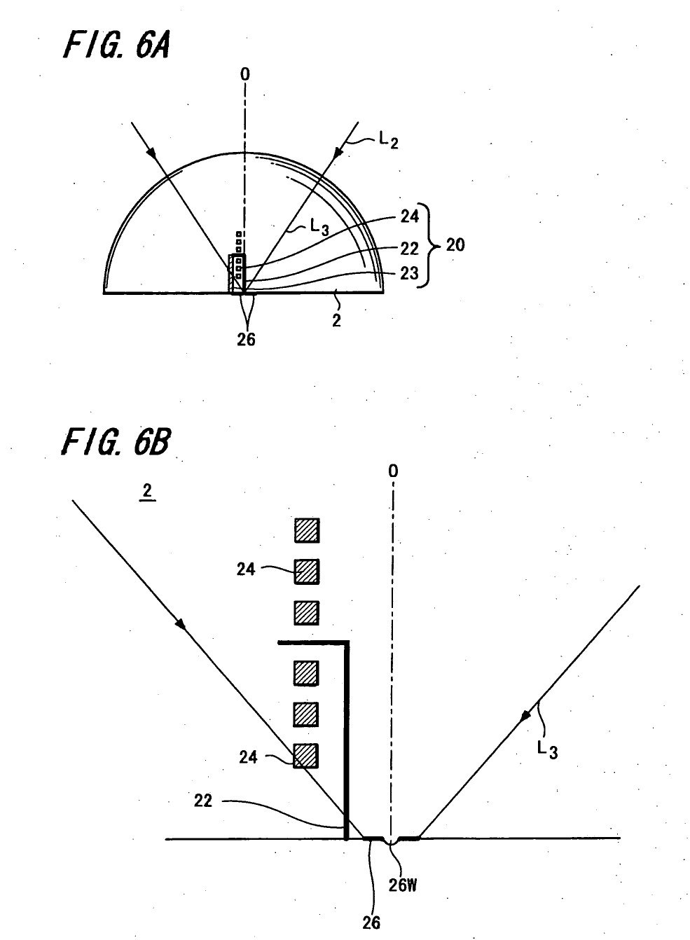

FIGS. 6A and 6B are respectively a schematic cross-sectional view showing an arrangement in which an aperture structure is formed on the bottom surface of the hemispherical or hyper-hemispherical lens 2 constructing the laser-assisted type magnetic recording head according to the present invention and a cross-sectional view showing a main portion of the hemispherical or hyper-hemispherical lens 2 in an enlarged-scale.

A recording thin-film magnetic head 20 constructing the laser-assisted type magnetic recording head 1 includes an aperture structure 26, made of a metal thin plate, for example, with an aperture 26W being formed thereon on the bottom surface of the hemispherical/hyper-hemispherical lens 2 at its position at which beam spot is formed by the focused light L₃ as shown in FIG. 6B.

Since light is unable to pass a very small aperture of a size less than a wavelength of light itself in the ordinary propagation mode, if a light transmission area of the bottom surface of the hemispherical/hyper-hemispherical lens 2 is limited to only the aperture 26W having a diameter ranging of from 10 nm to 100 nm by the aperture structure 26, for example, then near-field light is generated at the periphery of the aperture from the aperture 26W instead of incident light.

According to the arrangement in which the very small aperture 26W is formed by the aperture structure 26, it is possible to accurately control the diameter of the beam spot on the bottom surface of the hemispherical/hyper-hemispherical lens 2 and the relative position of the beam spot from the main magnetic pole 22.

As mentioned hereinbefore, in order to improve recording efficiency, it is desirable that the position at which the recording magnetic fields are applied and the center of the beam spot should be as close as possible. The reason for this is that, temperature gradient and maximum achievable temperature are lowered as the distance therebetween is increased, thereby resulting in recording efficiency being lowered. On the other hand, in order to locate the magnetic poles with ease, it is desirable that the center of the beam post and the magnetic pole should be distant from each other. From the above-mentioned aspects, it is preferable that the distance between the main magnetic pole 22 and the magnetic pole should be less than several 100s of nanometers. More preferably, it is desirable that the above distance should fall within a range of from 50 to 100 nm. Also, as a material constructing the aperture structure 26, it is particularly preferable that silver (Ag) or gold (Au), which may generate surface plasmon resonance in the visible light region, should be used as a material constructing the aperture structure 26 because a quantity of light generated from the aperture can be increased by Ag or Au.

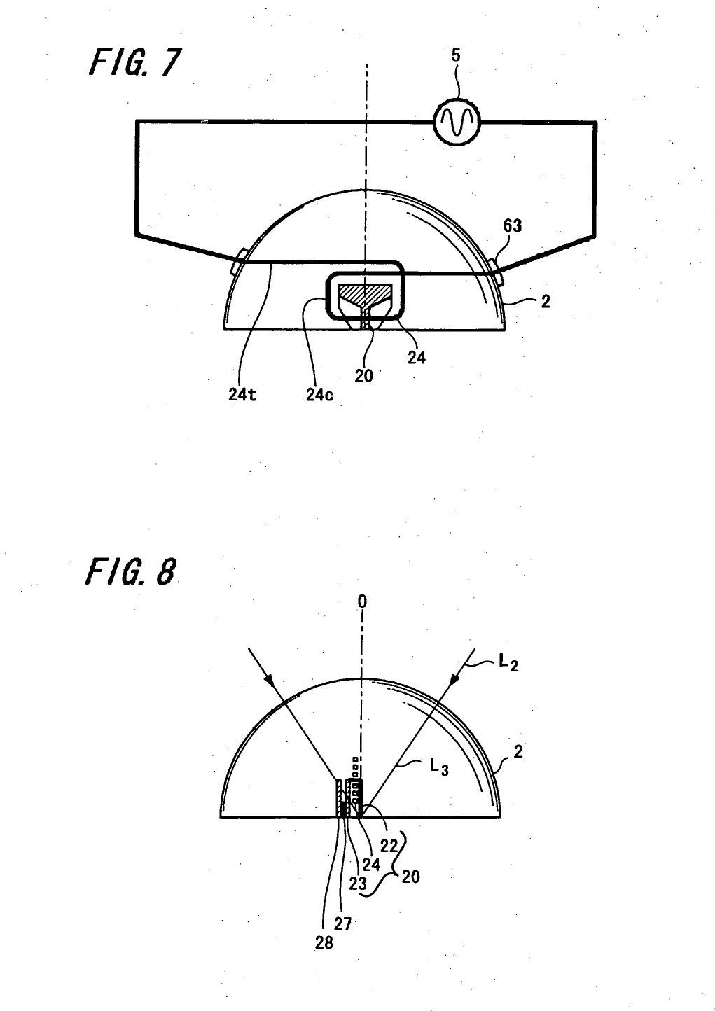

FIG. 7 is a schematic diagram showing a relationship between the hemispherical or hyper-hemispherical lens 2 and the signal power supply 5 which controls an electric current of the thin-film magnetic field generating thin-film coil 24 constructing the recording thin-film magnetic head 20.

A winding portion 24c of the magnetic field generating thin-film coil 24 is formed within a cone-like area, formed around the optical axis by incident light, within the hemispherical or hyper-hemispherical lens 2, an end portion 24t of the magnetic field generating thin-film coil 24 is extended up to the outer surface of the hemispherical or hyper-hemispherical lens 2 and the recording thin-film magnetic head 20 is connected through an electrode 63 formed on this outer surface to the signal power supply 5 by outside wiring.

As described above, in the laser-assisted type magnetic recording head 1, when the magnetic field generating thin-film coil 24 constructing the recording thin-film magnetic head 20 is energized by the signal power supply 5, magnetic fields are generated from the main magnetic pole 22 in the perpendicular recording head arrangement, for example.

While the magnetic field generating thin-film coil and the wiring pattern may be formed of a conductive metal thin film such as copper (Cu), it is preferable that they should be made of a transparent conductive material such as ITO (Indium-Tin-Oxide). While it is customary that the winding portion 24c of the magnetic field generating thin film coil 24 is formed in the area with a diameter ranging of from 10 μm to several 100s of nanometers and of which thickness is several micrometers, if it is made of a transparent conductive material whose optical quality such as a refractive index is equal to or similar to that of the material constructing the hemispherical/hyper-hemispherical lens 2, then an amount in which the focused light L₃ is scattered or reflected by the magnetic field generating thin-film coil 24 can be decreased and hence influences imposed on the shape of the above-mentioned beam spot also can be decreased.

Also, the arrangement of the laser-assisted type magnetic recording head 1 may be modified in such a manner that a portion led out from this wiring pattern to the outer edge portion of the hemispherical/hyper-hemispherical lens and the above-mentioned signal power supply 5 may be connected together by a suitable method such as wire bonding in the portion in which the wiring pattern of the bottom portion of the optical lens 2, for example, is led out and the electrode 63 formed outside the hemispherical/hyper-hemispherical lens 2.

FIG. 8 is a schematic cross-sectional view showing an arrangement of an example in which a thin-film magnetic reproducing head is laminated within the hemispherical/hyper-hemispherical lens 2 of the laser-assisted type magnetic recording head 1 according to the present invention.

The laser-assisted type magnetic recording head 1 according to the present invention may have an arrangement in which a magnetic reproducing head 28 is formed in the hemispherical/hyper-hemispherical lens 2 independently of the recording thin-film magnetic head 20.

The magnetic reproducing head 28 can be constructed by a highly-sensitive thin-film reproducing magnetic head such as a thin-film magnetoresistive (MR: Magnetoresistive) head, for example, an NiFe thin-film magnetoresistive (AMR: Anisotropic Magnetoresistive) head, a spin-valve head, a giant magnetoresistive (GMR: Giant Magnetoresistive) head and a tunneling magnetoresistive (TMR: Tunneling Magnetoresistive) head.

According to the above-mentioned arrangement in which the thin-film reproducing magnetic head 28 is provided within the hemispherical/hyper-hemispherical lens 2 together with the recording thin-film magnetic head 20, azimuth loss between the recording thin-film magnetic head 20 for laser-assisted magnetic recording and the reproducing magnetic head 28 can be decreased and hence it becomes possible to increase a recording density of the magnetic recording medium 11.

The laser-assisted type magnetic recording head 1 according to the present invention is mounted on a biaxial actuator serving also as the aforementioned gap adjusting means 62 and is able to perform focusing adjustment, tracking adjustment and gap adjustment superimposed on the focusing adjustment. The focusing adjustment is carried out such that a focusing point of the lens may coincide with the medium recording layer by using a near-field component of reflected light from the medium surface. According to the focusing adjustment, the distance between the bottom surface of the lens and the medium surface may be controlled so as to fall within a range of focal depth of lens, that is, within a rang of approximately ±100 nm. Thereafter, the distance between the bottom surface of the lens and the medium surface is made extremely close to each other by the gap adjustment. By way of example, the distance between the bottom surface of the lens and the medium surface should fall within a range of approximately 20±2 nm. A quantity of reflected light of the aforementioned near-field component from the surface of the medium can be used as a gap detecting signal. Since the bottom surface of the lens and the medium surface are made close to each other in the order of nanometers, gap control is important not only from a standpoint of generating near-field light but also from a standpoint of maintaining tribology reliability on the interface between the lens surface and the medium surface.

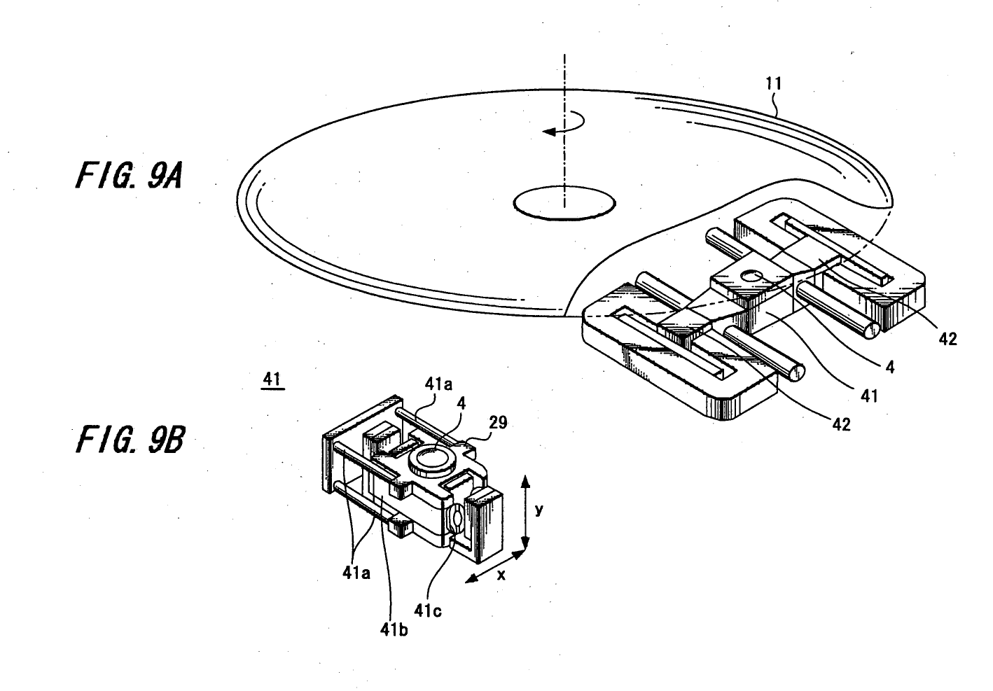

FIGS. 9A and 9B are both perspective views showing a relationship between the biaxial actuator and the magnetic recording medium 11 and show a biaxial actuator mechanism of the biaxial actuator.

As shown in FIGS. 9A and 9B, in this biaxial actuator, a biaxial actuator mechanism 41 includes a coarse actuator mechanism 42 and the magnetic recording medium, for example, a magnetic disc is coarsely adjusted in the radial direction by this coarse actuator mechanism 42.

The biaxial actuator mechanism 41 has the focusing lens system 4 mounted thereon. As shown in FIG. 9B, in the above-mentioned biaxial actuator mechanism 41, the focusing lens system 4 is supported within a supporting body 29, for example, by supporting springs 41a and the biaxial actuator mechanism 41 can be moved in the horizontal direction of the medium surface of the magnetic recording medium 11, that it, the tracking direction (shown by an arrow x in FIG. 9B) based on the aforementioned tracking servo signal by first and second voice coil motors 41b and 41c. Also, the biaxial actuator mechanism 41 can be moved in the direction perpendicular to the optical axis direction, that is, the focusing direction (shown by an arrow y in FIG. 9B) based on the focusing servo signal and the gap servo signal.

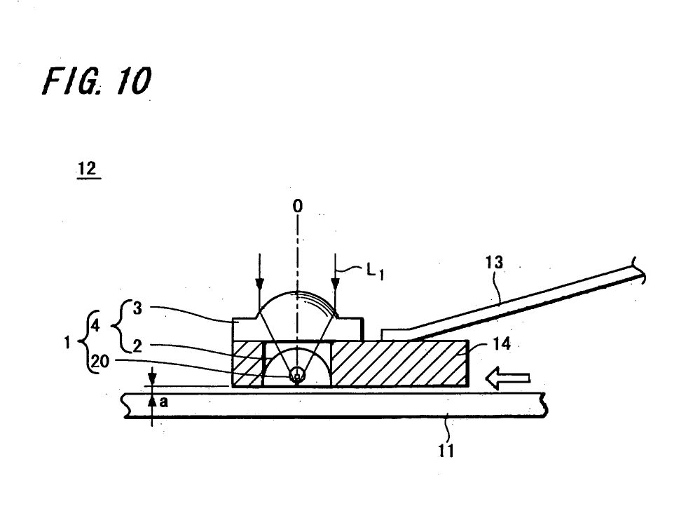

FIG. 10 is a partly cross-sectional side view in which the gap adjusting means 62 for keeping the gap of the laser-assisted type magnetic recording head 1 according to the present invention constant has an arrangement of a flying slider. According to this flying slider type arrangement, the laser-assisted type magnetic recording head 1 is mounted on a slider 14 supported at the free end of a suspension 13 and a gap between the laser-assisted type magnetic recording head 1 and the magnetic recording medium 11 is controlled by a flying amount of the flying slider 14 which can fly in accordance with movement or rotation of the magnetic recording medium 11 opposing the laser-assisted type magnetic recording head 1.

The magnetic recording apparatus according to the present invention is not limited to an active control type arrangement in which the focusing lens 4 and the laser-assisted type magnetic recording head 1 are controlled by the above-mentioned actuator and it may be also applied to a passive control type arrangement in which the flying slider can fly in accordance with movement or rotation (shown by an open arrow in FIG. 10) of the magnetic recording medium 11 opposing the hemispherical/hyper-hemispherical lens 2. The flying slider 14 having this arrangement and the flying mechanism based on this slider 14 can serve also as the above-mentioned adjusting means 62.

Next, a magnetic recording head manufacturing method according to the embodiment of the present invention will be described.

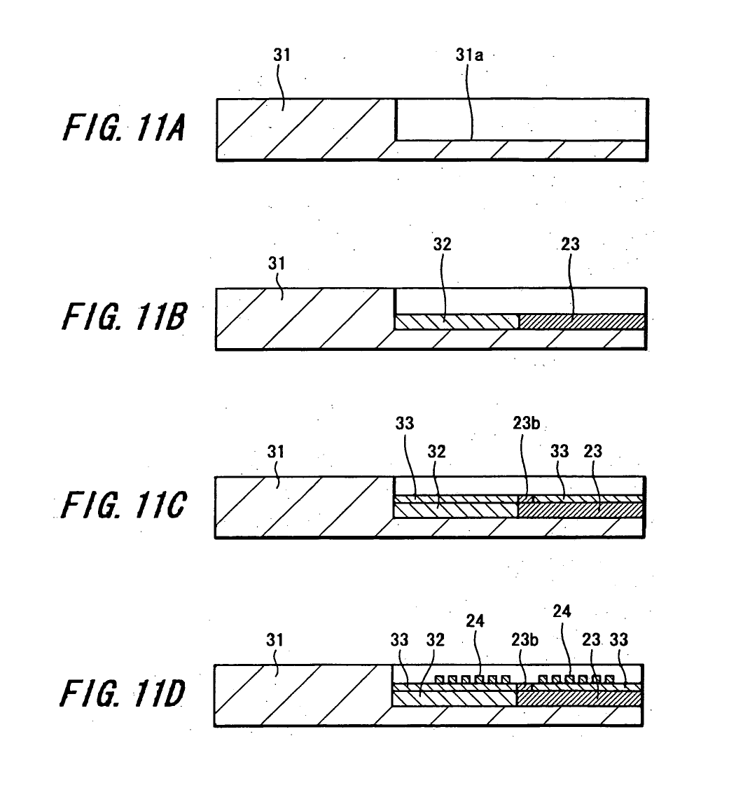

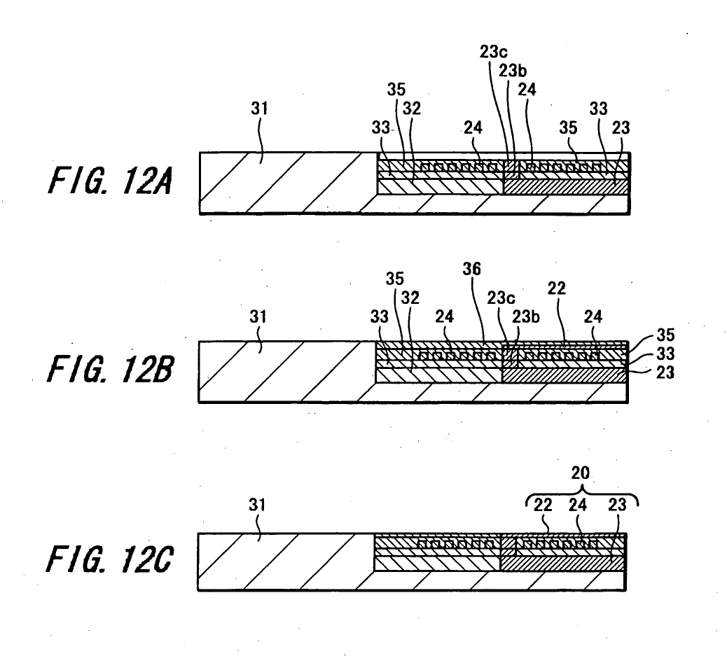

FIGS. 11A to 11D and FIGS. 12A to 12C are respectively process diagrams used to explain an example of a laser-assisted type magnetic recording head manufacturing method according to the present invention.

First, there is prepared a first optical member 31 made of a suitable material, which passes light with a predetermined wavelength, such as optical glass, SiC, alumina, quartz and a diamond substrate. Then, as shown in FIG. 11A, a groove 31a having a depth ranging of from several micrometers to several 10s of micrometers is formed at a predetermined position of the first optical member 31 by photolithography, for example, a Deep-RIE (Reactive Ion Etching) method.

The Deep-RIE method is adapted to etch the etched object deeply in the vertical direction as compared with the ordinary RIE method. This Deep-RIE method uses SF₆ and C₄F₈ as etching gas and etches the etched object by using mainly SF₆ and is able to deeply etch the etched object in the vertical direction by forming a protecting film on the side wall of a groove which is formed by etching based on mainly C₄F₈.

Subsequently, as shown in FIG. 11B, the second thin-film magnetic pole made of the high magnetic permeability material, that is, the sub-magnetic pole 23 is formed on the bottom portion side, that is, the end face side in the finally obtained magnetic head within the previously-formed groove 31a by resist patterning, plating or sputtering, for example. Then, an insulating layer 32 made of a suitable material such as SiO₂, alumina and resist having a height equal to the sub-magnetic pole 23 is formed within the groove 31a at its portion excepting the portion in which the sub-magnetic pole 23 is formed.

Then, as shown in FIG. 1C, a sub-magnetic pile bridging portion 23b is formed on the upper surface of a part of the sub-magnetic pole 23 by resist patterning, plating or sputtering and an interlayer insulator 33 is formed on the sub-magnetic pole 23 and the insulating film 32 excepting the portion in which this sub-magnetic pole bridging portion 23a is formed.

Subsequently, as shown in FIG. 1D, there is formed the coil 24 having a winding structure based on a conductive film such as Cu, Aluminum (Al) and ITO by resist patterning, plating or sputtering.

After that, as shown in FIG. 12A, the upper surface and side surface of the coil 24 are covered by forming the interlayer insulator 33 and a sub-magnetic pole bridging portion 23c is formed on the sub-magnetic pole bridging portion 23b by resist patterning, plating or sputtering.

Subsequently, as shown in FIG. 12B, the first thin-film magnetic pole, that is, the main magnetic pole 22 is formed from the sub-magnetic pole bridging portion 23c to the bottom portion side, that is, the end face side of the finally obtained magnetic head by resist patterning, plating or sputtering and an insulating film 36 is formed from the main magnetic pole 22 to the interlayer insulator 35 as a protecting film to cover the upper surface.

After that, as shown in FIG. 12C, the recording thin-film magnetic head 20 is formed within the groove 31a of the first optical member 31 by planarizing and polishing the first optical member 31 and the insulating film 36 formed on the upper portion of the groove 31a.

While the processes for manufacturing the perpendicular recording magnetic head as the recording thin-film magnetic head have been described so far, the ring inductive type head also can be formed by similar processes. When the reproducing thin-film magnetic head and the recording magnetic head are provided side by side, the recording magnetic head is formed after the reproducing magnetic head was formed by similar processes. According to the above-mentioned processes, the recording head can be located at the optical side of the lens.

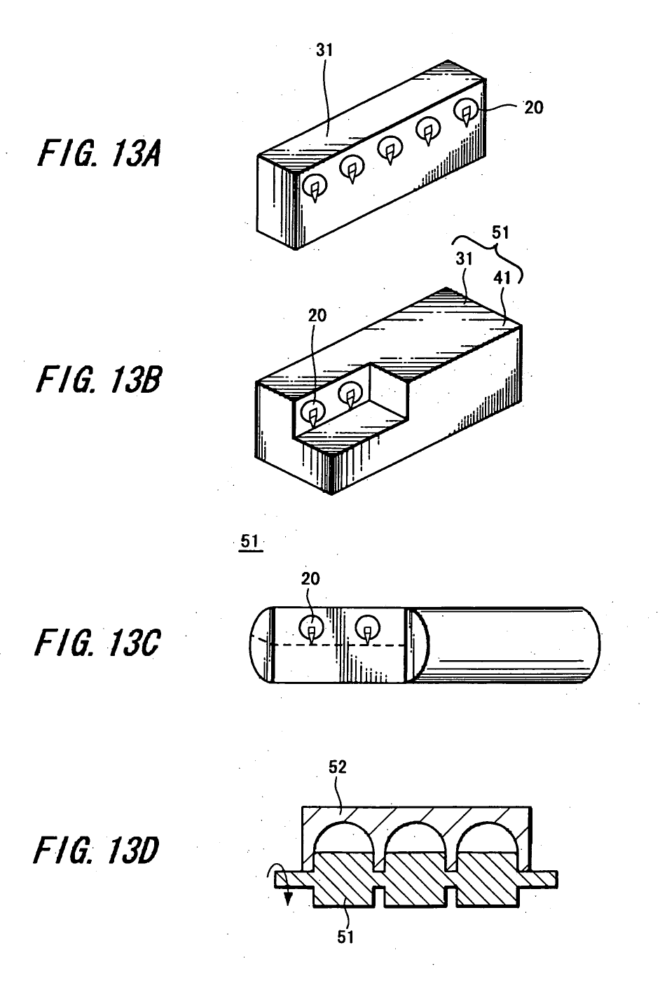

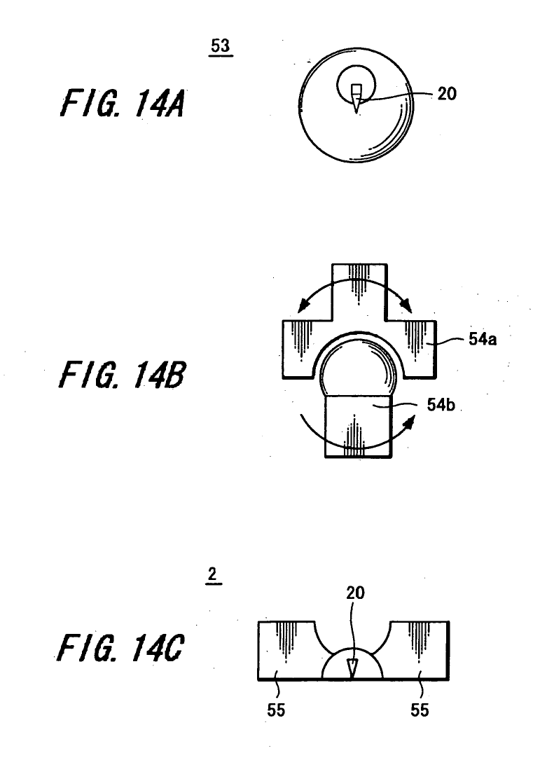

FIGS. 13A to 13D and FIGS. 14A to 14C are process diagrams used to explain the processes following the above-mentioned processes of an example of the laser-assisted type magnetic recording head manufacturing method according to the present invention.

First, as shown in FIG. 13A, there is prepared the first optical member 31 in which a large number of recording thin-film magnetic heads 20 are formed on the same end face obtained by the forming process of the above-mentioned magnetic head assembly. A second optical member 41 which passes light of the same wavelength band of the first optical member 31 is bonded to the first optical member 31 at its end face in which the recording thin-film magnetic head 20 is formed by bonding using optical adhesive or welding based on heating with pressure, that is, an optical contact method and thereby a joint body 51 is obtained.

Thereafter, as shown in FIG. 13C, the joint body 51 is formed as a circular cylinder body by mechanical polishing using a first polishing means 52. This circular cylinder joint body 51 is mechanical-polished at an interval such that each of the recording thin-film magnetic heads 20 is contained in the finally obtained spherical body in response to the interval at which a large number of previously formed recording thin-film magnetic heads 20 are formed, thereby resulting in a rough ball-like spherical body 53 being manufactured.

Subsequently, as shown in FIG. 14B, the rough ball-like spherical body 53 is formed as a spherical body having desired degree of vacuum and surface roughness and which demonstrates predetermined aberration amount relative to incident light by polishing the spherical body 53 of rough ball-like shape with a pair of opposing second polishing means 54a and 54b whose inner surfaces are formed as hemispherical curved surfaces while the spherical body 53 of rough ball-like shape is being rotated and swung.

After that, as shown in FIG. 14C, when this spherical body is fixed within a predetermined chip 55 and molded as a hemispherical or hyper-hemispherical shape having a predetermined height, there is obtained the hemispherical/hyper-hemispherical lens 2 containing the recording thin-film magnetic head 20. Then, the laser-assisted type magnetic recording head 1 consisting of the above-mentioned focusing lens system 4 and recording thin-film magnetic head 20 can be manufactured by combining this hemispherical/hyper-hemispherical lens 2 and the aforementioned objective lens 3 at desired position and angle.

In the manufacturing process of this laser-assisted type magnetic recording head 1, the magnetic field generating thin-film coil 24 may be extended in advance on the joint surface, which finally serves as the outer surface of the hemispherical/hyper-hemispherical lens 2, of the second optical member 41 and an electrode may be formed on the terminal portion of the magnetic field generating thin-film coil 24 exposed on the outer surface of the thus manufactured hemispherical/hyper-hemispherical lens 2 and thereby connected to the signal power supply 5.

The magnetic recording head, the magnetic recording apparatus and the magnetic recording head manufacturing method according to the present invention are not limited to these embodiments.

For example, in the magnetic recording head according to the present invention, not the sub-magnetic pole but the main magnetic pole can be used as an inner core around which coils can be wound or a plurality of coils which may be wound around one of the main magnetic pole and the sub-magnetic pole can be constructed.

Also, the magnetic recording medium is not limited to the arrangement similar to that of the related-art hard disk and it can be applied to an arrangement in which concavities and convexities of land and groove are formed in the direction crossing the longitudinal direction of the recording track, for example. Based on illumination of laser light on this magnetic recording medium, it is possible to obtain by detecting the reflected light of the illuminated laser light a tracking servo signal required when magnetic fields are applied by the laser-assisted type magnetic recording head.

While the magnetic recording apparatus for laser-assisted magnetic recording relative to the disc-like magnetic recording medium and the magnetic recording head constructing this magnetic recording apparatus have been described as the examples in the above-mentioned embodiments, the present invention is not limited thereto and can variously changed and modified in such a way as to apply the magnetic recording apparatus and the magnetic recording head of the present invention to laser-assisted magnetic recording relative to other magnetic recording mediums such as a tape-like magnetic recording medium.

As described above, in the laser-assisted type magnetic recording head according to the present invention, since the focusing lens system is composed of the objective lens and the hemispherical or hyper-hemispherical lens with the effective numerical aperture greater than 1.0 to generate near-field light, a diameter of a beam spot on a target magnetic recording medium can be reduced sufficiently. Further, according to the present invention, in the inside of the hemispherical or hyper-hemispherical lens of the focusing lens system, it is possible to effectively avoid light from being shielded by the magnetic heads within the lens.

Specifically, according to the present invention, since the focusing lens system has the numerical aperture greater than 1.0, that is, light is introduced into the focusing lens system with a wide angle, although the magnetic head is located between the lenses, it is possible to decrease the effect in which light is shielded by the magnetic head. Also, since this magnetic head has the arrangement of the thin-film head, this light-shielding effect can be suppressed much more. Accordingly, only a predetermined recording portion of the magnetic recording medium can be sufficiently heated by laser light of a light beam spot with a small diameter and hence coercive force can be lowered locally.

Then, since the recording magnetic head is located within the lens, the lens can be made sufficiently close to the magnetic recording medium.

Further, the position at which recording magnetic fields are applied and the laser-assisted spot can be placed in an ideal positional relationship, that it, both of them can be made substantially coincident or close to each other.

Further, since the magnetic head is located within the lens as described above, the magnetic head can be held mechanically with high stability. Hence, the magnetic head can be made sufficiently thin and small by the thin-film technology and magnetic fields can be applied to very small areas.

Furthermore, since the magnetic recording apparatus according to the present invention uses the above-mentioned laser-assisted type magnetic recording head of the present invention, there can be achieved similar effects. Then, since the magnetic recording apparatus according to the present invention includes the gap adjusting means, the gap of the laser-assisted type magnetic recording head relative to the magnetic recording medium can be set to be a predetermined one and hence the magnetic recording apparatus of the present invention can perform stable recording operations.

Then, since the laser-assisted arrangement uses the laser light, the gap servo signal, the focusing servo signal and the tracking servo signal can be obtained from reflected light (returned light) of light from the magnetic recording medium and the positional relationship between the magnetic head and the magnetic recording medium can fall within a predetermined relationship without providing special means.

Also, according to the manufacturing method of the present invention, since the spherical or hyper-hemispherical lens which houses therein the recording thin-film magnetic head constructing the laser-assisted type magnetic recording head can be manufactured at the same time the lens is formed, the manufacturing process can be simplified and a signal relationship between the lens and the magnetic head can be improved in accuracy.

It should be understood by those skilled in the art that various modifications, combinations, sub-combinations and alterations may occur depending on design requirements and other factors insofar as they are within the scope of the appended claims or the equivalents thereof.

1. A laser-assisted type magnetic recording head, comprising:
a focusing lens system including an objective lens and a hemispherical or hyper-hemispherical lens with an effective numerical aperture greater than 1.0 to generate near-field light; and
a recording thin-film magnetic head embedded in the hemispherical or hyper-hemispherical lens.

2. A laser-assisted type magnetic recording head according to claim 1, wherein the hemispherical or hyper-hemispherical lens has a bottom surface formed as a planar surface or a surface of a circular cone having a protruding portion at a central portion thereof.

3. A laser-assisted type magnetic recording head according to claim 2, wherein the recording thin-film magnetic head is a perpendicular recording magnetic recording head including a main magnetic pole formed of a thin-film magnetic pole to generate a recording magnetic field, a sub-magnetic pole formed of a thin-film magnetic pole for assisting recording and a magnetic field generating thin-film coil.

4. A laser-assisted type magnetic recording head according to claim 3, wherein the main magnetic pole is located from the protruding portion of the bottom surface to the inside of the hemispherical or hyper-hemispherical lens close to and in parallel to the optical axis of the hemispherical or hyper-hemispherical lens.

5. A laser-assisted type magnetic recording head according to claim 3, wherein the main magnetic pole has a small cross-section at the protruding portion on the bottom surface of the hemispherical or hyper-hemispherical lens.

6. A laser-assisted type magnetic recording head according to claim 3, wherein the main magnetic pole is located close to and in parallel to the optical axis of the focusing lens system, and an aperture structure of near-field light is formed on the optical axis of the focusing lens system.

7. A laser-assisted type magnetic recording head according to claim 1, wherein the recording thin-film magnetic head is a ring-like inductive magnetic head including first and second thin-film magnetic poles having a magnetic gap formed between tip end portions thereof and a magnetic field generating thin-film coil.

8. A laser-assisted type magnetic recording head according to claim 7, wherein the magnetic gap has a center selected at a position close to the optical axis of the focusing lens system, and an aperture structure of near-field light is formed on the optical axis of the focusing lens system.

9. A laser-assisted type magnetic recording head according to claim 1, wherein the recording thin-film magnetic head includes a magnetic field generating thin-film coil, the coil being formed of a transparent conductive material.

10. A laser-assisted type magnetic recording head according to claim 1, a magnetoresistive effect type thin-film reproducing magnetic head is located in the hemispherical or hyper-hemispherical lens, together with the recording thin-film magnetic head.

11. A magnetic recording apparatus, comprising:
a laser light source;
a laser-assisted magnetic recording head; and
gap adjusting means for controlling a gap between the laser-assisted magnetic recording head and a magnetic recording medium;
the laser-assisted magnetic recording head including a recording thin-film magnetic head for generating a magnetic field to the magnetic recording medium and a focusing lens system for focusing laser light from the laser light source on the magnetic recording medium; and
the focusing lens system including an objective lens and a hemispherical or hyper-hemispherical lens, an effective numerical aperture thereof being selected to be greater than 0.1, wherein when information is recorded on the magnetic recording medium, information is recorded on the magnetic recording medium based on magnetic fields generated from the thin-film magnetic head by focusing laser light from the laser light source on the magnetic recording medium through the focusing lens system in the state in which the gap of the laser-assisted magnetic recording head relative to the magnetic recording medium is adjusted by the gap adjusting means.

12. A magnetic recording apparatus according to claim 11, wherein the gap adjusting means includes a flying slider having the laser-assisted magnetic head mounted thereon.

13. A magnetic recording apparatus according to claim 11, further comprising detecting means for detecting reflected light of the laser light irradiated on the magnetic recording medium, a gap servo signal of the gap adjusting means being obtained by a detected output from the detecting means.

14. A magnetic recording apparatus according to claim 11, wherein the laser-assisted magnetic recording head is mounted on a biaxial actuator, the biaxial actuator adjusting two axes of the optical axis direction of the laser-assisted magnetic recording head and the direction perpendicular to the optical axis direction of the laser-assisted magnetic recording head.

15. A magnetic recording apparatus according to claim 12, wherein the reflected light detecting means generates from its detected output a focusing servo signal by which the optical system of the laser-assisted magnetic recording head is focus-servo-controlled relative to the magnetic recording medium.

16. A magnetic recording apparatus according to claim 11, wherein the reflected light detecting means generates from its detected output a tracking servo signal by which the recording thin-film magnetic head of the laser-assisted magnetic recording head applies magnetic fields to the magnetic recording medium.

17. A magnetic recording apparatus according to claim 11, further comprising:
a magnetic recording medium having concavities and convexities formed as lands and grooves with respect to a direction crossing a longitudinal direction of recording tracks; and
detecting means for detecting reflected light of the laser light irradiated on the magnetic recording medium, a detected output of the detecting means generating a tracking servo signal by which the recording thin-film magnetic head of the laser-assisted magnetic recording head applies magnetic heads to the magnetic recording medium.

18. A magnetic recording apparatus according to claim 11, wherein the magnetic recording medium includes a soft magnetic layer formed under a recording layer.

19. A laser-assisted type magnetic recording head manufacturing method, comprising:
forming a groove on an end face of a first optical member which passes light of a predetermined wavelength band;
forming a recording thin-film magnetic head within the groove;
covering the recording thin-film magnetic head with an insulating film including a protecting film;
planarizing and polishing the protecting film;
forming a joint body by joining a second optical member, which passes light of the same wavelength band as the wavelength band, on the optical member across the recording thin-film magnetic head within the groove; and
forming a hemispherical or hyper-hemispherical optical lens having the thin-film magnetic head embedded therein by spherical-polishing the joint body.

20. A laser-assisted type magnetic recording head manufacturing method according to claim 19, wherein the step of forming the recording thin-film magnetic head within the groove includes:
forming a first thin-film magnetic pole made of a high magnetic permeability material within the groove;
forming a magnetic field generating thin-film coil made of a metal conductive thin-film after an insulating film is formed on the first thin-film magnetic pole;
forming an insulating film on the magnetic field generating thin-film coil; and
forming a second magnetic pole made of a high magnetic permeability material on the insulating layer.

21. A laser-assisted type magnetic recording head manufacturing method according to claim 19, further comprising:
forming an electrode on the outer surface of the hemispherical or hyper-hemispherical optical lens, wherein a terminal portion of the magnetic field generating thin-film coil within the hemispherical or hyper-hemispherical optical lens is extended to the joint surface of the first optical member relative to the second optical member and thereby connected to the electrode on the outer surface of the hemispherical or hyper-hemispherical optical lens in the step of forming the magnetic field generating thin-film coil.
